(19) United States
(12) Patent Application Publication
(10) Pub. No.: US 2012/0226612 A1
(43) Pub. Date: Sep. 6, 2012

(54) SYSTEM AND METHOD FOR PROCESSING AN ON-LINE TRANSACTION

(76) Inventors: Taras Mark Kurtis, Vernon (CA); Christopher Mark Obsniuk, Northville, MI (US)

(21) Appl. No.: 13/039,659

(22) Filed: Mar. 3, 2011

(51) Int. Cl. G06Q 40/00

(52) U.S. Cl. 705/44

(57) ABSTRACT

A system and method for processing an order from a user. The system comprises an entry field displayed on a user's computer operable to receive a single code string having first and second portions and a transaction processor circuit in communication with the user's computer being configured to capture a single code string inputted by the user into the entry field and to separate the single code string into the first portion and the second portion and a database containing a plurality user's account each having a corresponding password. The method comprises, at the transaction processor circuit, separating the single code string into first and second portions, confirming that the first portion corresponds to a user's account, authenticating the identity of the user by comparing the second portion to a password corresponding to the user's account and causing a status code to be displayed on the user's display.

### BACKGROUND OF THE DISCLOSURE

1. Field of Disclosure

The present disclosure relates to on-line shopping and more specifically, to a method and system permitting a user to rapidly order products and services online with a minimum of input steps.

2. Description of Related Art

Electronic commerce (or e-commerce) relates to buying products and services over a computer network such as the internet. The volume and the value of e-commerce has increased significantly in recent years and now represents an important source of income for many companies as well as being a growing sector of the global economy.

One of the advantages of e-commerce over conventional retail is the speed at which goods and services may be purchased by a consumer. In conventional retail, it is necessary to visit or call a store or retail location to purchase the goods or services. Even in the case of telephone orders, it is frequently necessary to provide financial information so as to complete the transaction over the phone, including credit card or banking information. Conversely, in the case of e-commerce, a transaction may be completed by entering the required financial information into the designated locations on the website of the vendor.

Another advantage provided by ecommerce is the variety of products and services available from a single computer access point as well as the selection between different providers of such products and services. The numerous options available to consumers also poses a difficulty to vendors of such services. As there are many choices available for most services and products, there is significant competition to provide these products and services. Such competition provides a limited time frame to obtain the sale from each consumer before they attempt to or purchase the service from a competitor. A related difficulty is that as consumers have become accustomed to rapid sales and availability, their demand for rapid and convenient purchases has increased. As a result, the window of time available to a vendor to make a sale to the customer has grown shorter. There is therefore a need to make the time and steps necessary to purchase products in an on-line environment as short as possible.

Previous attempts to provide rapid methods of payment options for on-line purchases have not been satisfactory. In particular, conventional “shopping cart” methods have been commonly utilized. In such methods, a consumer may select one or more items from a vendor's website to be added to a list of items they wish to purchase which is commonly referred to as a shopping cart. The customer may then complete the purchase of their selection by proceeding to check out their shopping cart. In the check out procedure, the user is re-directed to a check out page where the total amount due for the order is calculated including taxes and shipping costs. The check out page may be either hosted by the vendor or by a third party. At the check out page, the customer may enter billing and mailing information to complete the transaction and thereafter be redirected back to the vendor's shopping page or a confirmation page.

One difficulty with present shopping cart methods is the necessity for the customer to provide not only credit card information when completing the order, but also to provide additional security information such as a personal identification number or a security code associated with the credit card and/or the name appearing on the credit card. The necessity to enter these multiple fields of data takes more time for a consumer and provides an opportunity for the consumer to loose interest in purchasing the product or service. Such systems may therefore be prone to having less customers purchase the service or product as an impulse purchase. Additionally, shopping carts requiring the input of credit card information may also put the consumer at risk for identity theft or fraud if the credit card information is determined by others which may provide a wrongdoer with full access to the credit card or bank account of the customer.

Another method for a consumer to pay for products or services may be to use a prepaid card or account having a unique assigned identity code and a user selected password. Such systems have the continuing disadvantage of requiring two separate data fields to be inputted thereby providing additional time for a consumer to change their mind about the purchase. This may particularly be possible when the consumer is purchasing relatively small value items or services such as access to a website. These methods also continue to have the risk of permitting any person who inadvertently learns of the details of the id and password code with full access to the account of the user.

### SUMMARY OF THE DISCLOSURE

According to a first embodiment of the present disclosure there is disclosed a system for processing an order from a user. The system comprises media storing an HTML document displayable on a user's computer display. The HTML document defines a payment web page and has an entry field operable to receive a single code string inputted into the entry field by the user. The single code has a first portion and a second portion. The system further includes a transaction processor circuit in communication with the user's computer, the transaction processor circuit being configured to capture the single code string inputted by the user into the entry field and to separate the single code string into the first portion and the second portion. The system further includes a database in communication with the transaction processor circuit containing a plurality user's account each having a corresponding password. The transaction processor circuit further being configured to confirm the first portion corresponds to a user's account in the database, to authenticate the identity of the user by comparing the second portion to the password corresponding to the user's account and to cause a status code to be displayed on the user's display indicating the status of the order requested by the user.

The system may further comprise media storing a vendors HTML document having a link thereon operable to redirect a web browser on the user's computer to the payment web page. The system may further comprise a server having the transaction processor circuit and the database therein.

The payment web page may further includes a security entry field to receive a security code wherein the transaction processor circuit verifies a correct response to confirm the user is a human user. The single code string further includes a third portion, the third portion being separated from the first and second portions by the transaction processor circuit, wherein the transaction processor circuit verifies a correct response to confirm the user is a human user. The third portion comprises a third data string corresponding to a computer unreadable image. The first and second portions each comprise a plurality of alphanumeric digits.

The status code indicates a successful transaction. The transaction processor circuit may further transmits an authorization code to at least one of the user's computer or a vendor's server. The status code indicates an unsuccessful transaction.

According to a further embodiment of the present disclosure there is disclosed a method for processing an order in an online environment. The method comprising displaying an entry field to a user on a payment web page on a user's display and capturing a single code string inputted into the entry field by a user, the single code string having a first portion and a second portion. The method further comprising at the transaction processor circuit, separating the single code string into the first portion and the second portion, confirming that the first portion corresponds to a user's account in a database operably coupled to the transaction processor circuit, authenticating the identity of the user by comparing the second portion to a password corresponding to the user's account and causing to be displayed on the user's display a status code indicating the status of the order requested by the user.

The method may further comprise redirecting a user's web browser from a vendor's web page to the payment web page upon receiving a payment request from the user. The method may further comprise entering a security code into a security entry field on the payment web page wherein the transaction processor circuit verifies a correct response to confirm the user is a human user.

The single code string further includes a third portion the third portion being separatable from the first and second portions by the transaction processor circuit, wherein the transaction processor circuit verifies a correct response to confirm the user is a human user. The third portion comprises a third data string corresponding to a computer unreadable image. The first and second portions each comprise a plurality of alphanumeric digits.

The status code indicates a successful transaction. The method may further comprise the transaction processing circuit transmitting an authorization code to at least one of the user's computer and a vendor's server. The status code indicates an unsuccessful transaction.

Other aspects and features will become apparent to those ordinarily skilled in the art upon review of the following description of specific embodiments in conjunction with the accompanying figures.

### BRIEF DESCRIPTION OF THE DRAWINGS

In drawings which illustrate embodiments wherein similar characters of reference denote corresponding parts in each view,

FIG. 1 is an illustration of a single code string for use in a system according to a first embodiment.

FIG. 2 illustrates a vendor's web page button operable to permit a user to pay utilizing the single code string code of FIG. 1.

FIG. 3 illustrates a web page having an input field single code string transaction according to a first embodiment.

FIG. 4 is a schematic of a system according to a first embodiment.

FIG. 5 is a flow diagram of a process utilizing a single input code to authorize a transaction.

FIG. 6 is an illustration of a single code string for use in a system according to a further embodiment.

FIG. 7 illustrates a web page having an embedded input field for accepting a single string code according to a further embodiment.

FIG. 8 illustrates a web page for managing the account of a user.

FIG. 9 illustrates a web page for managing the funds associated with each of at least one of a plurality of account having an associated single string code.

### DETAILED DESCRIPTION

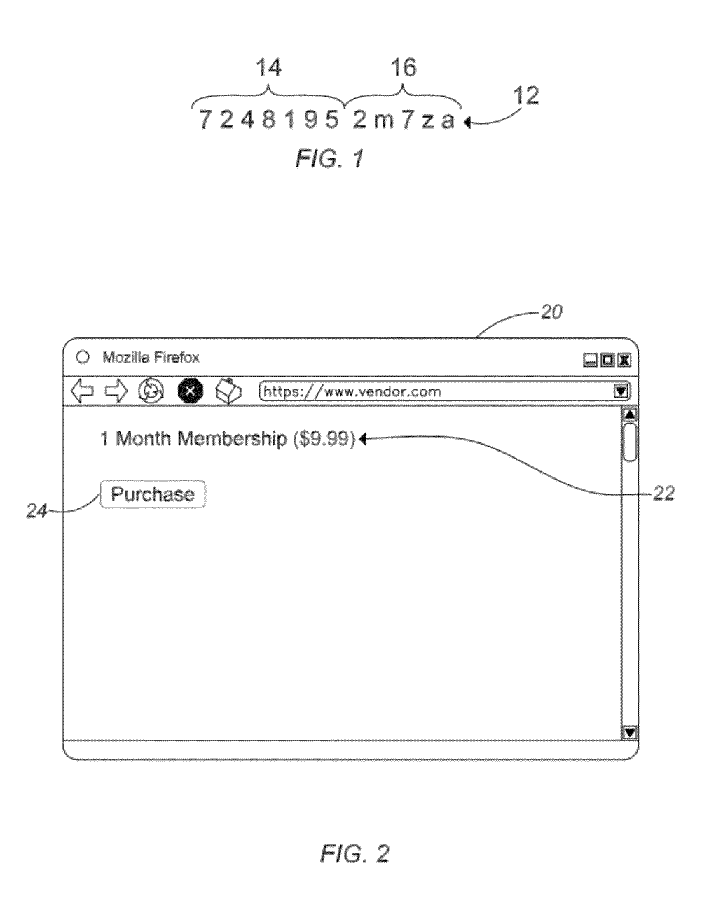

With reference to FIG. 1, a single code string for ordering and processing a transaction has a first portion 14, being an identification code and a second portion 16, being a personal identification number (PIN) code. The identification portion 14 is assigned by a managing computer system and is comprised of a series of non-sequential computer readable characters of a designated length, such as 7 digits as shown. The identification portion 14 may be either assigned by an operator of the managing computer system or may be automatically generated by the managing computer system according to predetermined rules or by random number generation techniques as are commonly known. The pin portion 16 is a string of 4 to 6 digits of non-sequential computer readable characters which are selected by the user. It will also be appreciated that other lengths of characters for the identification code or pin portion 16 may also be utilized. The computer readable characters may comprise numbers, letters and other ascii characters or any other suitable characters such as punctuation or non-English language characters. The use of a single code string reduces the number of separate inputs required from a user and permits an additional degree of security by permitting the user to maintain control of a portion of the single string code. Additionally, as will be more fully described below, the use of single string code as described provides additional security and limitations of risk.

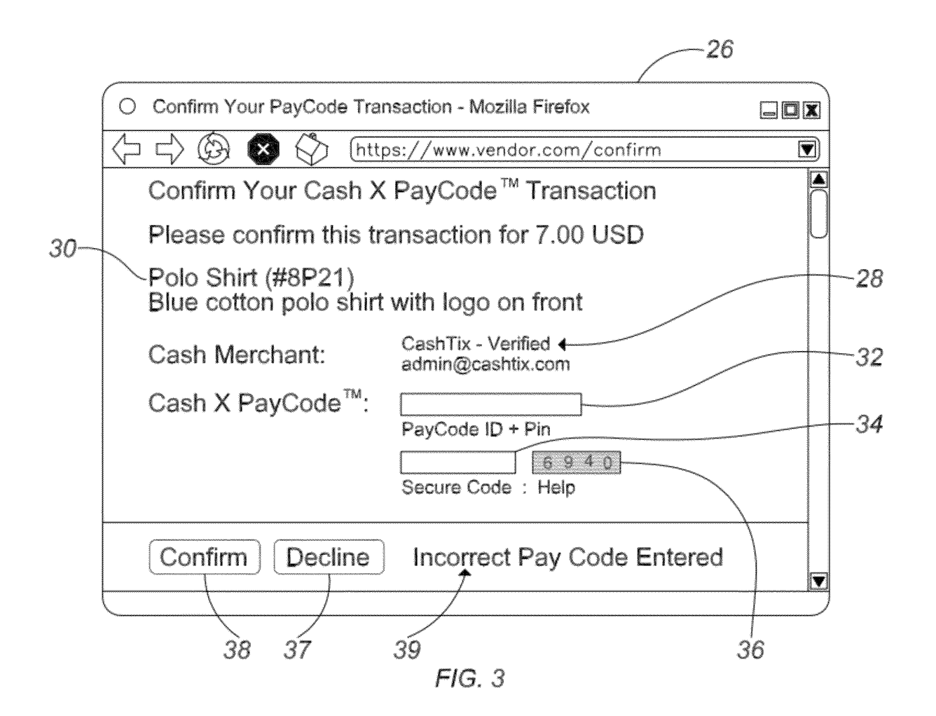

With reference to FIG. 2, in operation, a user accesses a vendor web page 20 which includes an html form imbedded thereon for displaying a purchase button 24 operable to forward the user to a secure payment web page as illustrated in FIG. 3. It will be understood by those of skill in the art that a web page is a Hyper Text Markup Language (HTML) document that is stored on a server and accessed and displayed on a user's computer display or screen through a web browser. As illustrated the vendor web page 20 may be offering for purchase access to the website or selected content therein and may include a description of the service being offered as indicated generally at 22.

When the user presses the purchase button 24, their web browser is redirected to a payment web page 26 as illustrated in FIG. 3 which is hosted by a secure server and may optionally be a payment transaction server as will be further described below. The html form transmits to the transaction server details concerning the proposed payment, including, without limitation, a description of the product or service being purchased, a currency amount and type and the vendor identification.

The payment web page 26 includes a confirmation of the identification of the vendor generally indicated at 28, as well as a confirmation of the item or service being purchased, generally indicated at 30 as transmitted to the transaction server from the html form. The payment web page 26 includes a code input field 32 to enter the single string code 12 and an optional security field 34 for the customer to enter a security verification code, such as by way of non-limiting example a CAPTCHA code 36 as to prevent the use of automated computer programs from attempting to hack or guess the security code. After entering the appropriate information in the code input field 32 and the security field 34, the user pushes the confirm button 38 so as to authenticate their purchase. The payment web page 26 may also include a cancel button 37 so as to offer the consumer the opportunity to cancel their purchase. After the purchase is authorized, the user will receive a confirmation of their purchase or access to the website which they were attempting to gain access to by being redirected back to the vendor's web site with an appropriate message displayed there. Optionally, a failure message may be displayed on the payment web site generally indicated at 39 for indicating to the user when an incorrect single string code 12 has been entered or if a predetermined number of incorrect attempts has been made so as to cause the system to block future attempts from that internet protocol (IP) address.

The use of a single string code entered into the payment web page provides a process for purchasing the product or service which is shortened and therefore the opportunities for a consumer to lose interest in completing the purchase are reduced. This is particularly advantageous in the case of low cost services or products where a consumer may be unwilling to commit a lengthy amount of time to purchase the product or service. The shortened purchase time and necessary steps also increases the probability that a consumer will purchase the product or service on an impulse.

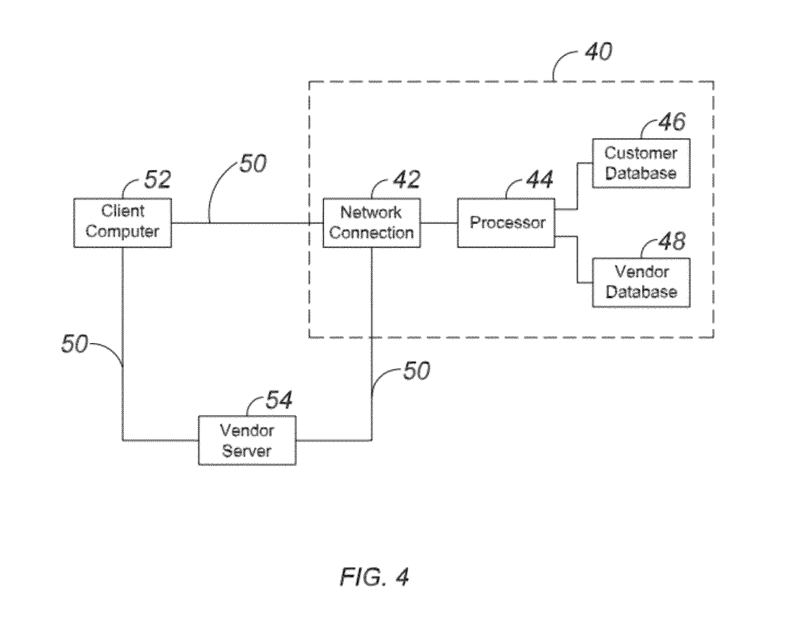

Turning to FIG. 4 a block diagram of a server system 40 of the present embodiment as interacting with client computer 52 and a vendor server 54 is illustrated. Although only a single client computer 52 and a single vendor server 54 are illustrated, it will be appreciated that a plurality of each of the vendor server and client computer may be utilized and in operation simultaneously and therefore the system illustrated in FIG. 4 only represents a single transaction. In operation, the present system may support any number of simultaneous transactions as described below by scaling of the server system 40 according to known methods.

The server system 40 is adapted to store, monitor and manage attempts to purchase products and services of a vendor by a particular customer having an account with an associated single string code 12. The server system 40 includes a network connector 42, such by way of non-limiting example, a modem, firewall or any other network adapter as will be understood and a transaction processor circuit 44. The processor circuit 44 may include a microprocessor, or more generally, in this specification, including the claims, the term “processor circuit” is intended to broadly encompass any type of device or combination of devices capable of performing the functions described herein, including (without limitation) other types of microprocessors, microcontrollers, other integrated circuits, other types of circuits or combinations of circuits, logic gates or gate arrays, or programmable devices of any sort, for example, either alone or in combination with other such devices located at the same location or remotely from each other, for example. Additional types of processor circuits will be apparent to those ordinarily skilled in the art upon review of this specification, and substitution of any such other types of processor circuits is considered not to depart from the scope of the present invention as defined by the claims appended hereto.

The server system 40 also includes a customer database 46 and a vendor database 48 in communication with the processor circuit 44 which may be stored on a common or separate memory devices which in this embodiment include a hard disk drive. Alternatively, however, any other suitable memory device or mechanism, such as random access memory, memory storage devices, optical storage devices, magnetic media, floppy disks, magnetic tapes and drives, hard drives, SIMMs, SDRAM, DIMMs, RDRAM, DDR RAM, SODIMMS, erasable programmable read-only memories (EPROMs), electrically erasable programmable read-only memories (EEPROMs), FLASH memory, compact disks, DVDs, and/or the like. In accordance with some embodiments, memory devices may include one or more disk drives, flash drives, databases, local cache memories, processor cache memories, relational databases, flat databases, and/or the like. In addition, those of ordinary skill in the art will appreciate many additional devices and techniques for storing information can be used as memory devices.

The server system 40 is in communication with a client computer 52 and a vendor server 54 via network connections 50, such as, by way of non-limiting example internet connections. In operation, a vendor web page 20 having the html form therein is retrieved by the client computer 52 from the vendor server 54 and displayed on the client computer for use by a customer. The customer initiates a transaction by pressing the purchase button 24 as set out above. The user's computer is then redirected to the payment web page 26 which may be hosted by the server system 40. On the payment web page 26, the user completes the transaction by entering their single string code 12 into the code input field 32 and the optional (if required) security code into the security field 34 and presses the confirm button 38. The server system 40 then receives this information, processes the transaction as described in more detail below and transmits back to the client computer 52 the status of the transaction and redirects the user's computer back to the vendor's web page 20. Optionally the server system 40 transmits to the vendor server 54 a confirmation of the status of the transaction which may include information relating to the value of the transaction as well or information describing the product or service purchased and optionally shipping instructions for the user.

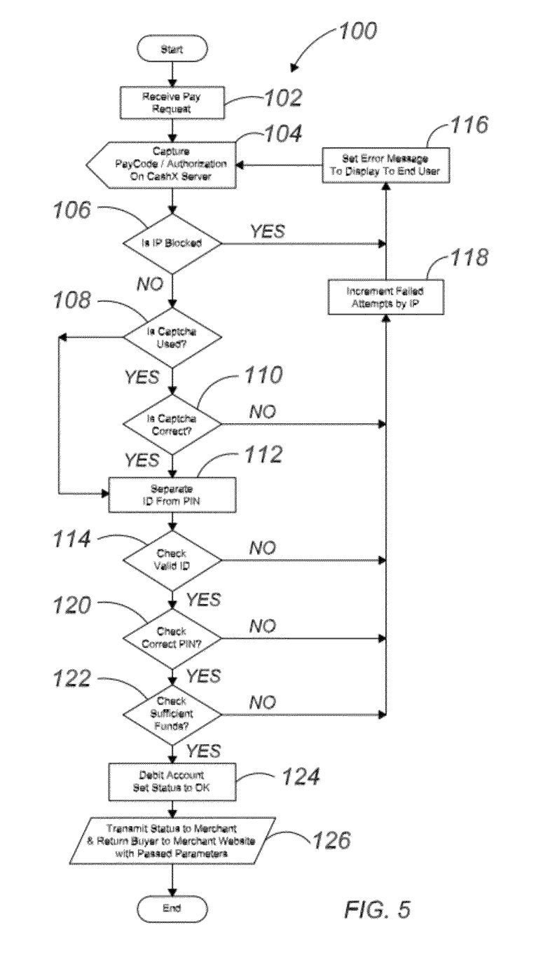

Turning to FIG. 5, a flow diagram of the transaction processing performed by the server system 40 is illustrated generally at 100. The process begins at step 102 when a transaction request is received from a client computer 52 as entered into the payment web page 26. The server system 40 then captures the single string code 12 from the payment web page 26 as entered by the user at step 104. The server system first checks the IP address of the user's computer against a list of blocked IP addresses maintained by the server system. If the user's computer does not have a blocked IP address the server system continues to process the proposed payment. If the user's computer does have a blocked IP address, the server system sets the error message to be displayed to the user to indicate that their IP address is blocked and transmits that message to the user at step 116. At step 108, the server system 40 checks if a security code, such as by way of non-limiting example a CAPTCHA code is utilized. If a security code is utilized, the server system 40 checks if the security code was entered correctly at step 110. If the security code was entered correctly, the server system continues to process the proposed transaction. If the security code was not entered correctly, the server system increases a failed attempts counter by one increment at step 118 and sets the error message to be displayed to the user to indicate that their the incorrect code was entered and transmits that message to the user at step 116.

The server system separates the single string code 12 into the identification portion 14 and the pin portion 16 as set out above according to the parameters set for the system at step 112. By way of example, the system may be set to have identification and pin portions 14 and 16 of a designated length and will therefore separate the single string code into these constituent components accordingly. Optionally, the system may be configured to utilized single string codes 12 having identification and pin portions of varying lengths with the distinctions between the identification and pin portions being defined by differences of a character type therebetween or by utilizing a designated character type to indicate the division between the identification and pin portions. At step 114 the system checks the validity of the separated identification portion 14 against data contained within the customer database 46. If the separated identification portion 14 is not located within the customer database 46, the server system increases a failed attempts counter by one increment at step 118 and sets the error message to be displayed to the user to indicate that their the incorrect code was entered and transmits that message to the user at step 116. Once the separated identification portion 14 is located within the customer database 46, the separated pin potion 16 is confirmed against the pin corresponding to the identification portion contained within the customer database at step 112. If the separated pin portion 16 does not correspond to the pin portion associated with the located identification portion contained within the customer database 46, the server system increases a failed attempts counter by one increment at step 118 and sets the error message to be displayed to the user to indicate that their the incorrect code was entered and transmits that message to the user at step 116.

Once the validity of the single string code 12 is authenticated, the server system 40 checks if there is sufficient funds available to process the proposed transaction associated with that single string code 12 at step 122. If there are sufficient funds associated with that singles string code 12, the server system 40 debits those funds from the user's single string code 12 account and sets the transaction status to OK at step 124 before transmitting this status to the client computer at step 126. If there are not sufficient funds associated with that singles string code 12, the server system increases a failed attempts counter by one increment at step 118 and sets the error message to be displayed to the user to indicate that there was insufficient funds for the proposed transaction and transmits that message to the user at step 116.

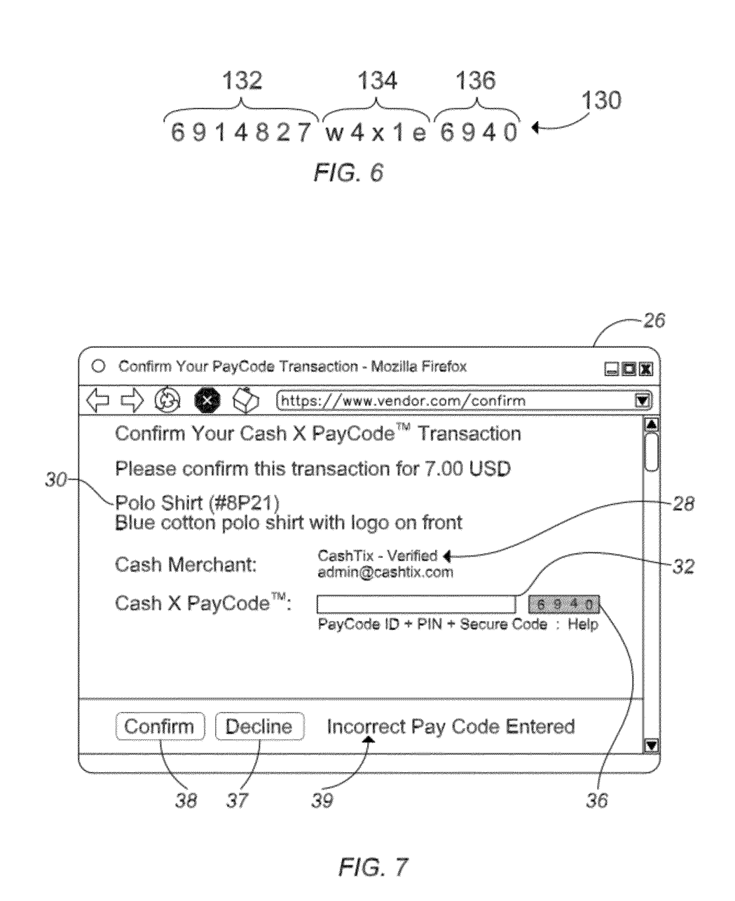

With reference to FIGS. 6 and 7, an alternative embodiment of the single string code 130 for ordering and processing a transaction may include a first portion 132, being an identification code, a second portion 134 being a personal identification number (PIN) code and a third portion 136 corresponding to a security code 36 displayed on the webpage 26. As set out above, a user accesses a vendor web page 20 which includes an html form imbedded thereon for displaying a purchase button 24 operable to forward the user to a secure payment web page as illustrated in FIG. 7. The payment web page 26 according to the present embodiment includes a code input field 32 to enter the single string code 130. As illustrated, the webpage displays a CAPTCHA code 36 which forms the third portion 136 of the single string code 130. The user has an assigned identification code 132 and pin number 134 and in operation, to complete the transaction, the user enters their identification code 132, pin number 134 and the displayed CAPTCHA code as a single string. After entering the appropriate information in the code input field 32 the user pushes the confirm button 38 so as to authenticate their purchase according to the method as described above. After the purchase is authorized, the user will receive a confirmation of their purchase or access to the website which they were attempting to gain access to without ever leaving the vendor's website.

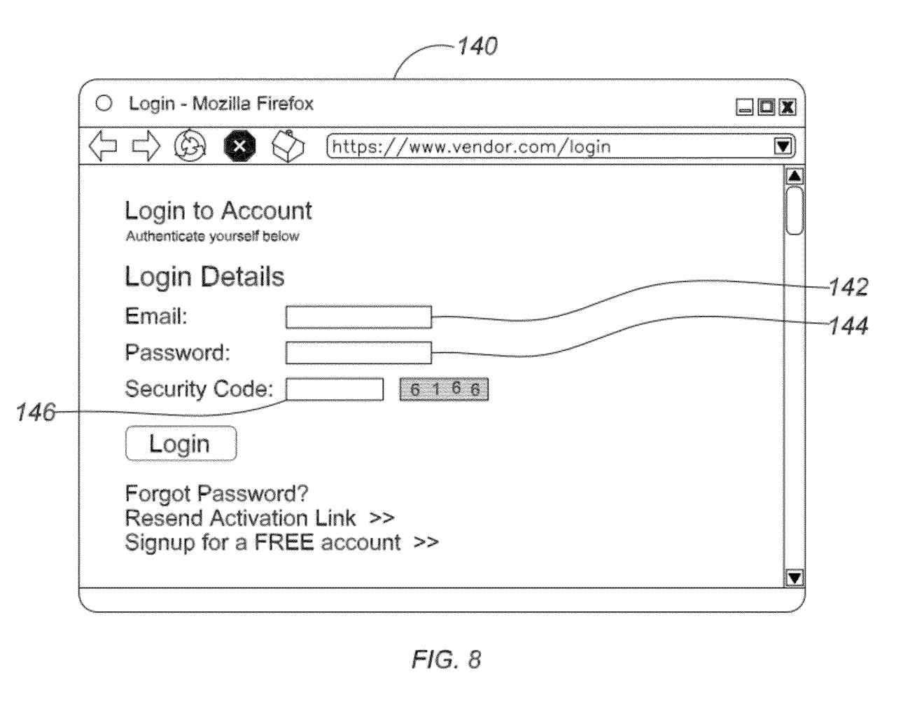

With reference to FIG. 8, the server system 40 may provide an optional user account management website 140. The account management website 140 includes fields for entering the email address 142 or other identification code and password 144, along with an additional security password 146 so as to limit access to the account details. The user may access the account management website 140 and enter their email address, password and the displayed security code 142, 144 and 146 so as to gain access to and manage their account settings. In particular the user may be permitted to change the pin number portion of their account if another person inadvertently learns it or periodically as desired.

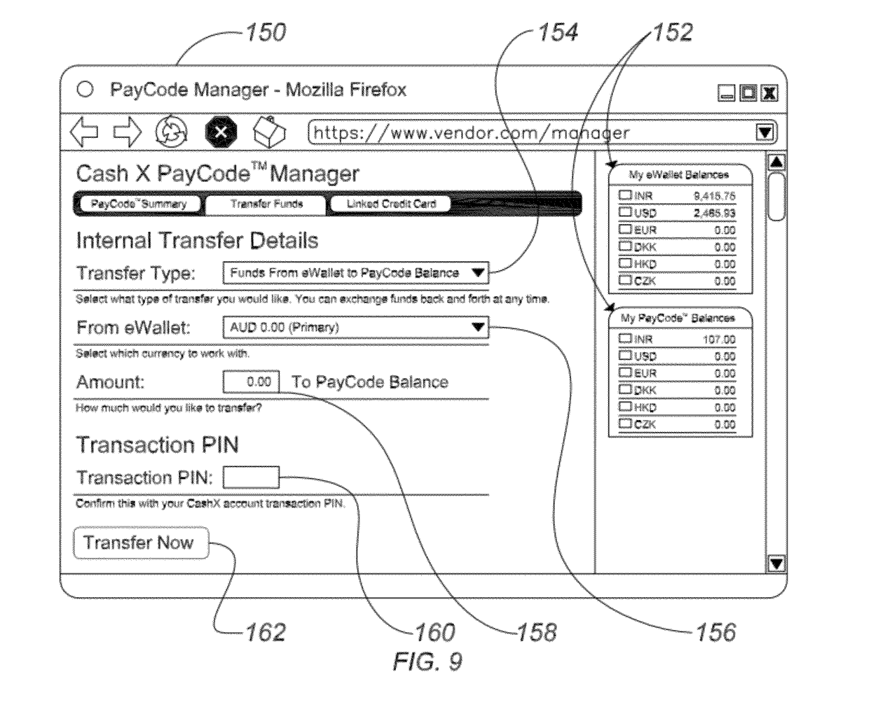

Optionally, a user may have more than one account in the present system as illustrated in FIG. 9 showing an accounts management page 150 of the system accessible through the account management website 140 or being otherwise secured. As illustrated, a user may have one or more single code string account or paycode account or more electronic wallet 152. The account management page 150 may have means for transferring funds between a user's accounts or into and out of their accounts, such as, from a credit card or bank account. By way of non-limiting example, the accounts management page may include a pull down menu to select the type of funds transfer desired 154, a pull down menu to select the source of the transfer 156 and a transfer input field 158 to enter the funds amount to be transferred or converted. A transfer button 162 or other means of initiating the transfer as well as a security code input field 160 may also be provided to ensure that only the authorized user is completing the funds transfer. Each of the single code string accounts 152 may have a different identification code and pin number so as to limit access by any single string code to a single account. In this way should another person learn of one of the user's single string codes, they will only gain access to that account and not all of the funds held by that user.

While specific embodiments of the invention have been described and illustrated, such embodiments should be considered illustrative of the invention only and not as limiting the invention as construed in accordance with the accompanying claims.

What is claimed is:

1. A system for processing an order from a user, the system comprising:
media storing an HTML document displayable on a user's computer display, said HTML document defining a payment web page and having an entry field operable to receive a single code string inputted into said entry field by the user, said single code having a first portion and a second portion,
a transaction processor circuit in communication with said user's computer, said transaction processor circuit being configured to capture said single code string inputted by said user into said entry field and to separate said single code string into said first portion and said second portion; and
a database in communication with said transaction processor circuit, said database containing a plurality user's account, each of said plurality of user's accounts having a corresponding password,
said transaction processor circuit further being configured to confirm said first portion corresponds to a user's account in said database, to authenticate the identity of said user by comparing said second portion to said password corresponding to said user's account and to cause a status code to be displayed on said user's display indicating the status of the order requested by the user.

2. The system of claim 1 further comprising media storing a vendors HTML document having a link thereon operable to redirect a web browser on said user's computer to said payment web page.

3. The system of claim 1 further comprising a server having said transaction processor circuit and said database therein.

4. The system of claim 1 wherein said payment web page further includes a security entry field to receive a security code wherein said transaction processor circuit verifies a correct response to confirm said user is a human user.

5. The system of claim 1 wherein said single code string further includes a third portion, said third portion being separated from said first and second portions by said transaction processor circuit, wherein said transaction processor circuit verifies a correct response to confirm said user is a human user.

6. The system of claim 5 wherein said third portion comprises a third data string corresponding to a computer unreadable image.

7. The system of claim 1 wherein said first and second portions each comprise a plurality of alphanumeric digits.

8. The system of claim 1 wherein said status code indicates a successful transaction.

9. The system of claim 8 wherein said transaction processor circuit further transmits an authorization code to at least one of said user's computer or a vendor's server.

10. The system of claim 1 wherein said status code indicates an unsuccessful transaction.

11. A method for processing an order in an online environment, the method comprising:
displaying an entry field to a user on a payment web page on a user's display;
capturing a single code string inputted into said entry field by a user, said single code string having a first portion and a second portion;
at said transaction processor circuit, separating said single code string into said first portion and said second portion;
confirming that said first portion corresponds to a user's account in a database operably coupled to said transaction processor circuit;
authenticating the identity of said user by comparing said second portion to a password corresponding to said user's account; and
causing to be displayed on said user's display a status code indicating the status of the order requested by the user.

12. The method of claim 11 further comprising redirecting a user's web browser from a vendor's web page to said payment web page upon receiving a payment request from said user.

13. The method of claim 11 further comprising entering a security code into a security entry field on said payment web page wherein said transaction processor circuit verifies a correct response to confirm said user is a human user.

14. The method of claim 11 wherein said single code string further includes a third portion said third portion being separatable from said first and second portions by said transaction processor circuit, wherein said transaction processor circuit verifies a correct response to confirm said user is a human user.

15. The method of claim 19 wherein said third portion comprises a third data string corresponding to a computer unreadable image.

16. The system of claim 11 wherein said first and second portions each comprise a plurality of alphanumeric digits.

17. The method of claim 11 wherein said status code indicates a successful transaction.

18. The method of claim 17 further comprising said transaction processing circuit transmitting an authorization code to at least one of said user's computer and a vendor's server.

19. The method of claim 11 wherein said status code indicates an unsuccessful transaction.
